(19) United States
(12) Patent Application Publication
(10) Pub. No.: US 2020/0194770 A1
(43) Pub. Date: Jun. 18, 2020

(54) TITANIUM-BASED ACTIVE ELECTRODES WITH HIGH STABILITY COATING LAYER

(71) Applicant: GuangXi University, Nanning (CN)

(72) Inventors: Shuangfei WANG, Nanning (CN); Xinliang LIU, Nanning (CN); Chengrong QIN, Nanning (CN); Zhan LEI, Nanning (CN); Shuangxi NIE, Nanning (CN); Shuangquan YAO, Nanning (CN); Chen LIANG, Nanning (CN); Yang LIU, Nanning (CN); Zhiwei WANG, Nanning (CN)

(73) Assignee: GuangXi University

(21) Appl. No.: 16/264,958

(22) Filed: Feb. 1, 2019

(30) Foreign Application Priority Data
Dec. 14, 2018 (CN) 201811536164.0

(51) Int. Cl. H01M 4/04; H01M 4/38

(52) U.S. Cl. CPC H01M 4/0404; H01M 4/045; H01M 4/38; H01M 4/0471; H01M 4/0419

(57) ABSTRACT

The patent provides a method for preparing titanium-based active electrodes with high stability coating layer, which belongs to the field of electrochemistry. The patent describes the active electrode is used titanium as the substrate, multi-metal oxides as the activated catalytic layer, and dense oxides as the protective layer. The multi-metal catalytic layer is formed by pyrolysis method to form the main body of titanium-based catalytic layer, and the dense oxide protective layer is combined with Sol-gel method and electrochemical deposition method to form a dense protective layer of titanium base. It can be widely used in chlor-alkali industry, paper industry, sewage treatment and other fields.

### CROSS-REFERENCE TO RELATED APPLICATION

This application claims the benefit of Chinese Patent Application No. 201811536164.0, filed on Dec. 14, 2018. The subject matter thereof is hereby incorporated herein by reference in its entirety.

### FIELD

The present invention generally relates to electrochemistry, and more particularly to, a method for preparing titanium-based active electrodes with high stability coating layer.

### BACKGROUND

The coated titanium-based electrodes use titanium or titanium alloy as a base material and are coated with oxide of ruthenium (Ru), iridium (Ir), titanium (Ti), manganese (Mn), vanadium (V), tantalum (Ta), niobium (Nb). The oxide of metal ions, such as ruthenium (Ru), iridium (Ir), titanium (Ti), manganese (Mn), vanadium (V), tantalum (Ta), niobium (Nb), show good electrochemical stability, high catalytic efficiency, high oxygen potential, low chlorine potential.

The coated titanium-based electrodes may be designed in different shape, structure, even with different metal ratio, to reach the different requirements in different applications. The coated titanium-based electrodes may be used in chlor-alkali industry, paper industry, sewage treatment and other fields.

Current preparation methods of coated titanium based electrode plates include thermal decomposition method, Sol-gel method, electrochemical deposition method, to name a few. According to the different application and requirements of electrodes, different structures of coated titanium-based electrode plates are designed by a thermal decomposition method, a Sol-gel method and an electrochemical deposition method. The activity and the stability of coated titanium-based electrode plate are different. While the coated titanium-based electrode plate coating preparation methods are diverse and include simple processes with high activity, the life cycle is short, as well as the substrate is prone to passivation and the coating is prone to cracking.

Thus, an alternative method may be beneficial.

### SUMMARY

Certain embodiments of the present invention may provide solutions to the problems and needs in the art that have not yet been fully identified, appreciated, or solved by current titanium-based active electrodes preparation processes. Some embodiments generally pertain to a process for preparing titanium-based active electrodes with a high stability coating layer.

In one embodiment, the process includes dispersing one or more compounds of Ru, Ir, Ti, and Mn to isopropyl alcohol or concentrated hydrochloric acid-isopropanol solutions, respectively. The process also includes mixing suspensions of the one or more compounds in a certain proportion at a certain temperature, and transferring the mixture to an electrode plate with a brush coating or spraying technology. The process further includes drying a layer on the coated electrode plate. The drying of the layer on the coated electrode plate is annealed to make the metals oxide calcined onto a plate. The process also includes coating compounds of Ru to a coating surface by a Sol-gel method and a electrochemical deposition method, and moving the activated titanium made into high temperature furnace annealing with nitrogen atmosphere to obtain the titanium-based active electrodes with the high stability coating layer.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating titanium-based active electrodes 100 with a high stability coating layer, according to an embodiment of the present invention.

FIG. 2 is a flow diagram illustrating a process for preparing titanium-based active electrodes with a high stability coating layer, according to an embodiment of the present invention.

### DETAILED DESCRIPTION OF THE EMBODIMENTS

Some embodiments generally pertain to a method for preparing titanium-based active electrodes with a high stability coating layer by a thermal decomposition method, a Sol-gel method, and/or a electrochemical deposition. The titanium-based active electrodes with the high stability coating layer has high electrocatalytic activity, long life, not easy shedding of coating density, and more activity.

To solve the technical problem of coated titanium electrode plate, some embodiments include a highly stable active titanium-based cationic material with titanium as the substrate, multi-metal oxides as the activated catalytic layer, and dense oxides as the protective layer. In some embodiments, the multi-metal catalytic layer is used to form the main catalytic layer by the pyrolysis method. The protective layer is combined with Sol-gel method and electrochemical deposition method to form a dense protective layer of titanium base.

The titanium base is titanium or titanium alloy, and the catalytic coating and protective layer include a mixture of titanium dioxide, manganese dioxide, ruthenium dioxide, vanadium pentoxide, ruthenium oxide and iridium dioxide, one or more of which is a certain proportion of the co-crystallization.

Scheme 1

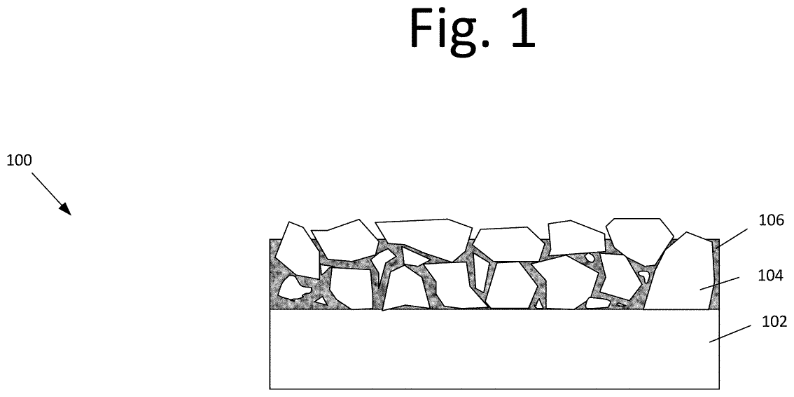

FIG. 1 is a diagram illustrating titanium-based active electrodes 100 with a high stability coating layer, according to an embodiment of the present invention. In an embodiment, titanium-based active electrodes 100 include titanium substrate 102, multi-metal active catalytic coating 104, and a dense metal oxide dense oxide protective layer 106.

In certain embodiments, titanium-based active electrodes 100 with high stability coating layer are prepared as follows.

In step 1, titanium substrates are polished, oiled and acid corroded by sandblasting. In step 2, titanium tetrachloride, ruthenium acetate, iridium acid and potassium permanganate are mixed with isopropyl alcohol. The mixture is then transferred to a titanium plate by way of spraying technology. In step 3, a coated titanium substrate is dried in an environment at a temperature ranging between 80 and 90 degrees Celsius. The coated titanium substrate is then transferred to a high temperature furnace, which is at a temperature ranging between 500 and 700 degrees Celsius, in argon atmosphere for 5 to 20 minutes.

This process, step 2 and step 3, is repeated 15 to 20 times to obtain the titanium-based active electrodes.

Once the titanium-based active electrodes is obtained, in step 4, the titanium-based active electrodes are used as a cathode, the graphite is used as an anode, and the RuCl₃ is used as the precursor. A ruthenium oxide protective layer is deposited onto pyrolysis cracking seam by electrochemical deposition, the current is controlled in range of 3-9 mA/cm², simultaneous drip plus NaOH, and electrodeposition 150 to 250 minutes.

At step 5, the deposited titanium-based active electrodes is transferred to a high temperature furnace, ranging between 150 and 200 degrees Celsius, in a nitrogen atmosphere annealing 5 to 10 minutes.

Scheme 2

In an embodiment, titanium-based active electrodes 100 with high stability coating layer may include a titanium substrate 102, multi-metal active catalytic coating 104, and dense metal oxide dense oxide protective layer 106.

In certain embodiments, titanium-based active electrodes 100 with high stability coating layer are be prepared using the followings steps. In this embodiment, at step 1, the titanium substrate is sandblasted for polishing, oil removal and acid corrosion. At step 2, RuCl₃ as the precursor is dispersed in hydrochloric acid-ethanol solution, and after aging and preheating, the NaOH is dripped. The electrolyte is obtained. At step 3, with the titanium substrate as anode, platinum as cathode, ruthenium oxide protective layer is deposited by electrochemical deposition, controlling the in range of 3-9 mA/cm², electrodeposition 150-250 min.

Continuing, at step 4, the titanium tetrachloride and ruthenium trichloride are dispersed in isopropyl alcohol respectively, and the mixture is transferred to the ruthenium-oxide titanium substrate by brush coating technology. At step 5, the coated titanium substrate is dried at a temperate ranging between 80 and 90 degrees Celsius and then is transferred to a high temperature furnace, which includes an argon atmosphere, having a temperature ranging between 400 and 550 degrees Celsius and annealing for 5 to 20 minutes;

The above steps are repeated at least 15 to 20 times until polymetallic catalytic ruthenium oxide titanium substrates is obtained.

Next, at step 6, RuCl₃ as the precursor is dispersed in boiling hydrochloric acid, separated and the ruthenium oxide colloidal solution is obtained. At step 7, ruthenium oxide titanium substrates from the earlier steps is impregnated into ruthenium oxide colloidal solution. At step 8, the impregnated titanium substrates is moved or transferred into nitrogen atmosphere high temperature furnace, which anneals at 150 to 200 degrees Celsius and for 5 to 10 minutes.

Scheme 3

In an embodiment, titanium-based active electrodes 100 with high stability coating layer, as shown in FIG. 1, includes titanium substrate 102, multi-metal active catalytic coating 104, and a dense metal oxide dense oxide protective layer 106.

In some embodiments, titanium-based active electrodes 100 with high stability coating layer are prepared by first (step 1) mixing titanium dioxide, vanadium pentoxide, ruthenium trichloride, iridium chloride with isopropyl alcohol, and then transferring the mixture to a titanium plate in turn by spraying technology. Next (step 2), the coated titanium substrate is dried at a temperature ranging between 80 and 90 degrees Celsius. The dried substrate is then transferred into a high temperature furnace in argon atmosphere annealing at 300 to 500 degrees Celsius for 5 to 20 minutes. This process is repeated 15 to 20 times, polymetallic catalytic ruthenium oxide titanium substrates is obtained. At step 3, RuCl₃ as the precursor is dispersed in boiling hydrochloric acid, separated and the ruthenium oxide colloidal solution is obtained. At step 4, ruthenium oxide titanium substrates of the previous step is impregnated into ruthenium oxide colloidal solution. At step 5, the impregnated titanium substrates are moved or transferred into a nitrogen atmosphere high temperature furnace annealing at 150 to 200 degrees Celsius for 5 to 10 minutes.

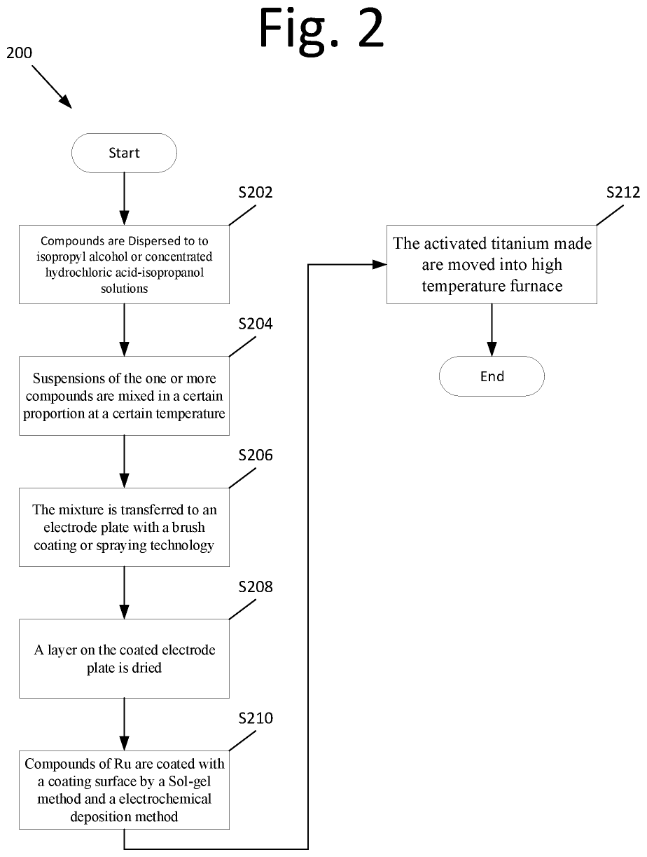

FIG. 2 is a flow diagram illustrating a process 100 for preparing titanium-based active electrodes with a high stability coating layer, according to an embodiment of the present invention. At S202, one or more compounds of Ru, Ir, Ti, and Mn are dispersed to isopropyl alcohol or concentrated hydrochloric acid-isopropanol solutions, respectively. At S204, suspensions of the one or more compounds are mixed in a certain proportion at a certain temperature, and at S206, the mixture is transferred to an electrode plate with a brush coating or spraying technology. At S208, a layer on the coated electrode plate is dried. The drying of the layer on the coated electrode plate is annealed to make the metals oxide calcined onto a plate. At S210, compounds of Ru are coated with a coating surface by a Sol-gel method and a electrochemical deposition method, and at S212, the activated titanium made are moved into high temperature furnace annealing with nitrogen atmosphere to obtain the titanium-based active electrodes with the high stability coating layer.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A process for preparing titanium-based active electrodes with a stability coating layer, the process comprising:
dispersing one or more compounds of Ru, Ir, Ti, and Mn to isopropyl alcohol or hydrochloric acid-isopropanol solutions, respectively;
mixing suspensions of the one or more compounds in proportion at a predefined temperature;
transferring the mixture of the suspensions to an electrode plate by way of brush coating or spraying technology;
drying a first layer on the electrode plate that was brushed coated or sprayed, wherein the drying of the first layer on the electrode plate comprises annealing the first layer of the electrode plate to make metals oxide calcined onto the electrode plate;
coating compounds of Ru with a coating surface by a Sol-gel method and a electrochemical deposition method to form a dense protective layer on the titanium-based active electrodes;
moving activated titanium into a temperature furnace; and
annealing activated titanium with a nitrogen atmosphere in the temperature furnace to obtain titanium-based active electrodes with the dense protective layer acting as the stability coating layer.

2. The process of claim 1, wherein the one or more compounds of Ru, Ir, Ti, and Mn comprise of one or more of Titanium tetrachloride, Ruthenium(III)oxoacetate, Ruthenium(III) chloride, Ruthenium oxide, Iridium dioxide, Iridium chloride, iridium chloride, and potassium permanganate.

3. The process of claim 1, wherein a ratio of at least two or more of the Ru, Ir, Ti, and Mn is about (0.1-3):(0.2-1):(1-6):(0-0.5) in molar mass ratio.

4. The process of claim 1, wherein the temperature during the drying of the first layer is 80-90° C., and the temperature inside of the temperature furnace is 300-700° C.

5. The process of claim 1, wherein the temperature inside of the temperature furnace is 150-200° C.
